(19) United States
(12) Patent Application Publication
(10) Pub. No.: US 2015/0245143 A1
(43) Pub. Date: Aug. 27, 2015

(54) CONDENSER MICROPHONE

(71) Applicant: KABUSHIKI KAISHA AUDIO-TECHNICA, Tokyo (JP)

(72) Inventor: Hiroshi AKINO, Tokyo (JP)

(21) Appl. No.: 14/592,529

(22) Filed: Jan. 8, 2015

(30) Foreign Application Priority Data
Feb. 24, 2014 (JP) 2014-032664

(51) Int. Cl. H04R 9/08

(52) U.S. Cl. CPC H04R 9/08

(57) ABSTRACT

In a condenser microphone that has a function of attenuating a low frequency component and can effectively suppress distortion or thermal noise and external noise of a signal, an impedance converter converting a change in capacitance between a diaphragm and a fixed electrode of a condenser microphone unit into an audio signal is included. An output signal of the impedance converter is supplied to a low frequency inversion signal generation circuit including a low-pass filter and a phase inversion circuit. An output of the low frequency inversion signal generation circuit is added to the diaphragm and a low frequency signal of wind noise or vibration noise is subtracted from a microphone output. An audio signal in which the wind noise or the vibration noise has been decreased is extracted as an unbalanced output between an output terminal of the impedance converter and a reference potential point of a circuit.

### BACKGROUND OF THE INVENTION

1. Field of the Invention

The present invention relates to a condenser microphone that decreases wind noise or vibration noise.

2. Description of the Related Art

In order to decrease wind noise or vibration noise included in an output of a condenser microphone, a filter circuit is arranged in a front step of an output circuit of the condenser microphone. Because the wind noise or the vibration noise is mainly a low frequency component, a high-pass filter (low-cut filter) for low frequency attenuation is used as the filter circuit.

The condenser microphone includes an electrostatic microphone unit that includes a diaphragm and a fixed electrode arranged at a predetermined interval to face each other. In the condenser microphone, because output impedance is high, an impedance converter is usually connected to a rear portion of the microphone unit.

In many cases, a field effect transistor (FET) is used in the impedance converter and the high-pass filter for the low frequency attenuation is arranged in a rear step of the impedance converter (for example, refer to JP 2001-238287 A).

FIG. 4 illustrates an example of a condenser microphone according to the related art that includes a filter for low frequency attenuation. In FIG. 4, a reference numeral 1 denotes a diaphragm and a reference numeral 2 denotes a fixed electrode facing the diaphragm 1. In the example illustrated in FIG. 4, a back electret condenser microphone is configured by arranging an electret material on a surface of the fixed electrode 2 facing the diaphragm 1.

The fixed electrode 2 is connected to an impedance converter 21 on which the FET is mounted and an output terminal of the impedance converter 21 is connected to a high-pass filter 30 including a condenser C30 and a resistor R30.

In this case, because impedance is high, an output side of the high-pass filter 30 is configured such that an output thereof is supplied to a buffer amplifier 31 by an emitter follower circuit.

The diaphragm 1 is connected to a reference potential point of a circuit and an audio output terminal Out of the microphone is configured between an output terminal of the buffer amplifier 31 and the reference potential point (ground potential point) of the circuit. That is, in the example illustrated in FIG. 4, an unbalanced output microphone is configured.

The high-pass filter 30 that is arranged between the impedance converter 21 and the buffer amplifier 31 includes the condenser C30 connected in series between the impedance converter 21 and the buffer amplifier 31 and the resistor R30 connected in parallel between the impedance converter 21 and the buffer amplifier 31 and the reference potential point. In the condenser C30, impedance changes according to a frequency of an audio signal output from the microphone unit side.

Therefore, when a signal frequency output from the microphone unit side is low, impedance by the condenser C30 increases and output impedance of the microphone unit side viewed from the buffer amplifier 31 is almost impedance by the resistor R30.

For this reason, when the impedance by the resistor R30 increases, noise (thermal noise) applied to the buffer amplifier 31 increases, external noise is easily received, and a noise level from the buffer amplifier 31 increases.

Therefore, it is considered that a resistance value of the resistor R30 is set to a small value, to decrease the thermal noise or the external noise. In this case, in a normal audio signal region, because the impedance by the condenser C30 decreases, synthesis impedance obtained by adding the resistor R30 of the small value is applied as a large load to the impedance converter 21. As a result, a signal output generated from the impedance converter 21 is distorted.

As described above, according to the condenser microphone according to the related art including the filter for the low frequency attenuation, depending on the frequency of the audio signal output from the microphone unit side, the distortion by the impedance converter 21 occurs or the thermal noise and the external noise by the buffer amplifier 31 occurs.

### SUMMARY OF THE INVENTION

An object of the present invention is to provide a condenser microphone of an unbalanced output that has a function of attenuating a low frequency component to prevent wind noise or vibration noise from occurring and can effectively suppress distortion or thermal noise and external noise of a signal generated according to a signal frequency output from the side of a microphone unit.

According to an aspect of the present invention, there is provided a condenser microphone including a condenser microphone unit configured to include a diaphragm and a fixed electrode arranged at a predetermined interval to face each other and an impedance converter configured to convert a change in capacitance between the diaphragm and the fixed electrode of the condenser microphone unit into an audio signal. An output terminal of the impedance converter is connected to a low frequency inversion signal generation circuit including a low-pass filter and a phase inversion circuit and configures an audio signal output terminal of the condenser microphone, an output terminal of the low frequency inversion signal generation circuit is connected to the diaphragm, and an input terminal of the impedance converter is connected to the fixed electrode.

According to another aspect of the present invention, there is provided a condenser microphone that includes a condenser microphone unit including a diaphragm and a fixed electrode arranged at a predetermined interval to face each other and an impedance converter configured to convert a change in capacitance between the diaphragm and the fixed electrode of the condenser microphone unit into an audio signal. An output terminal of the impedance converter is connected to a low frequency inversion signal generation circuit including a low-pass filter and a phase inversion circuit and configures an audio signal output terminal of the condenser microphone, an output terminal of the low frequency inversion signal generation circuit is connected to the fixed electrode, and an input terminal of the impedance converter is connected to the diaphragm.

In addition, an audio signal output of the condenser microphone is an unbalanced output.

In addition, the low frequency inversion signal generation circuit preferably includes the low-pass filter connected to the output terminal of the impedance converter and the phase inversion circuit connected to an output terminal of the low-pass filter and an output terminal of the phase inversion circuit is configured as the output terminal of the low frequency inversion signal generation circuit.

According to the condenser microphone according to the aspects of the present invention, for example, the low frequency inversion signal from the microphone is extracted from the low frequency inversion signal generation circuit and is supplied to the diaphragm. As a result, the low frequency inversion signal is added to the audio signal generated from the microphone unit.

Therefore, the low frequency signal is subtracted in the audio signal received from the impedance converter. Thereby, occurrence of the wind noise or the vibration noise can be greatly decreased.

In addition, because the audio signal in which the wind noise or the vibration noise has been decreased can be extracted from the impedance converter, occurrence of distortion by the impedance converter to be caused by the impedance change of the high-pass filter illustrated in the example according to the related art and occurrence of thermal noise or external noise by the buffer amplifier can be effectively prevented.

### BRIEF DESCRIPTION OF THE DRAWINGS

FIG. 1 is a block diagram illustrating a signal generation circuit of a condenser microphone according to the present invention;

FIG. 2 is an exploded view illustrating a basic configuration of the condenser microphone according to the present invention;

FIG. 3 is a block diagram illustrating another configuration of the signal generation circuit of the condenser microphone according to the present invention; and

FIG. 4 is a block diagram illustrating an example of a signal generation circuit of a condenser microphone according to the related art.

### DESCRIPTION OF THE PREFERRED EMBODIMENTS

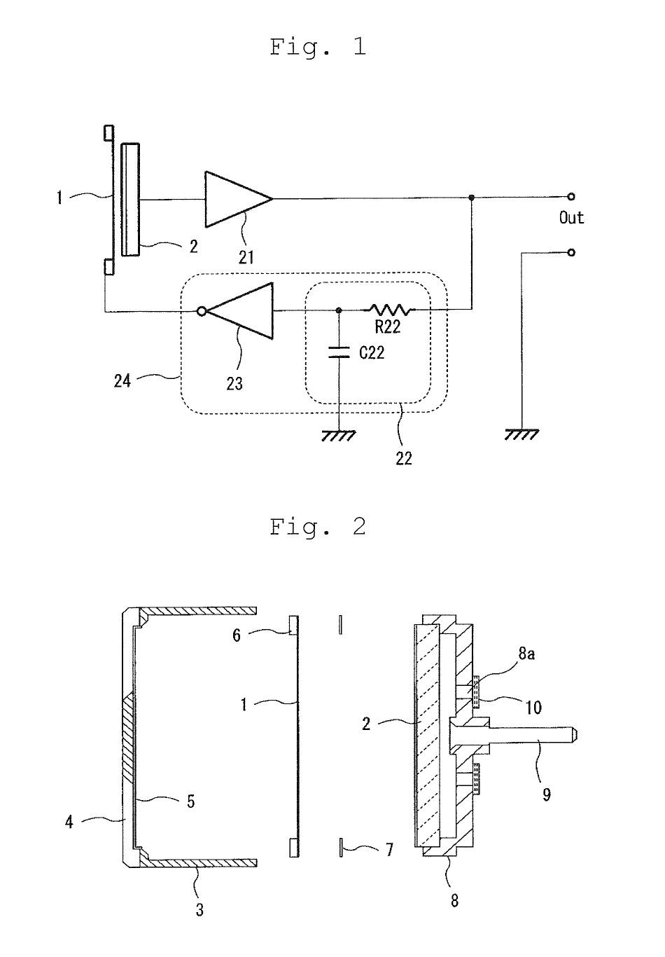

A condenser microphone according to the present invention will be described on the basis of embodiments illustrated in the drawings. First, FIG. 1 is a block diagram illustrating a signal generation circuit according to a first embodiment.

Reference numerals 1 and 2 denote a diaphragm and a fixed electrode that are included in a condenser microphone unit and are arranged at a predetermined interval to face each other, respectively. In a configuration illustrated in FIG. 1, the fixed electrode 2 is connected to an input terminal of an impedance converter 21 and an FET is source-follower connected to the impedance converter 21 and is mounted to the impedance converter 21, as already known.

By this configuration, the impedance converter 21 achieves a function of converting a change in capacitance between the diaphragm 1 and the fixed electrode 2 into a voltage signal and outputting the voltage signal. Thereby, an audio signal by the microphone unit is extracted.

A low-pass filter 22 is connected to an output terminal of the impedance converter 21. The low-pass filter 22 includes a resistor R22 of which one end is connected in series to the output terminal of the impedance converter 21 and a condenser C22 which is connected between the other end of the resistor R22 and a reference potential point (ground potential point) of a circuit.

The low-pass filter 22 extracts a low frequency signal for wind noise or vibration noise acting on the microphone unit and the low frequency signal extracted by the low-pass filter 22 is supplied to a phase inversion circuit 23. Therefore, a low frequency inversion signal generation circuit 24 is formed by the low-pass filter 22 and the phase inversion circuit 23.

In addition, the low-pass filter 22 and the phase inversion circuit 23 in the low frequency inversion signal generation circuit 24 can achieve the same function, even when collection order of the low-pass filter 22 and the phase inversion circuit 23 is changed.

An output signal from the low frequency inversion signal generation circuit 24 is supplied to the diaphragm 1 configuring the microphone unit. Therefore, a low frequency inversion signal for the wind noise or the vibration noise is added to an audio signal generated by the microphone unit.

For this reason, the low frequency signal for the wind noise or the vibration noise is subtracted in the audio signal received from the impedance converter 21.

In addition, in the configuration illustrated in FIG. 1, an audio signal output terminal Out of the microphone is configured between the output terminal of the impedance converter 21 and the reference potential point of the circuit. That is, in the example illustrated in FIG. 1, an unbalanced output microphone is configured.

According to the configuration described above, the audio signal in which the wind noise or the vibration noise has been decreased can be extracted from the impedance converter 21. Therefore, the high-pass filter illustrated in the example according to the related art does not enter a transmission path of the audio signal.

Thus, a microphone that can obtain a high dynamic range in which there is not occurrence of distortion by the impedance converter caused by existence of the high-pass filter or reception of thermal noise or external noise by the buffer amplifier does not occur can be provided.

FIG. 2 illustrates a basic configuration of the condenser microphone including the diaphragm 1 and the fixed electrode 2 illustrated in FIG. 1 and is a cross-sectional view illustrating a state in which the condenser microphone unit is dismantled into main portions particularly.

In the condenser microphone unit, the diaphragm 1 receiving a sound wave and vibrating and the fixed electrode 2 have condenser elements arranged to face each other with an air layer of a predetermined interval therebetween and the condenser elements are assembled in a unit case 3.

That is, the unit case 3 has a cylindrical shape in which multiple sound introduction holes 4 are provided at a front surface side and a rear surface side is opened. The unit case 3 is formed of a metal material such as brass. Front meshes 5, the diaphragm 1 attached to a diaphragm holder 6 having a ring shape, a spacer 7 having a ring shape, the fixed electrode 2 formed of a metal material, and an insulation base 8 formed of a synthetic resin are inserted into the unit case 3 from the rear surface side.

In addition, an electret layer is arranged on a surface of the fixed electrode 2 facing the diaphragm 1.

The fixed electrode 2 is supported by the insulation base 8 to be electrically insulated from the unit case 3 and the diaphragm 1. In addition, an extraction electrode rod 9 to extract a signal from the fixed electrode 2 is attached to a center portion of the insulation base 8.

A plurality of communication holes 8a communicating with a unit back surface are formed at appropriate positions of the insulation base 8 and the communication holes 8a are closed by an acoustic resistor 10 attached to a back surface of the insulation base 8. Thereby, a unidirectional microphone unit is configured.

A lock ring not illustrated in the drawings is attached to an inner circumferential surface of a rear portion of the unit case 3, predetermined pressing force is applied to the fixed electrode 2 through the insulation base 8 at the side of the diaphragm holder 6, and entire unit components including the diaphragm holder 6 and the fixed electrode 2 are fixed to an inner portion of the unit case 3.

Further, a cylindrical body case (microphone case) not illustrated in the drawings is attached to the rear portion of the unit case 3, a substrate on which the circuit configuration illustrated in FIG. 1 is mounted and an output connector functioning as the audio signal output terminal Out are stored in the body case, and an electret condenser microphone is thereby configured.

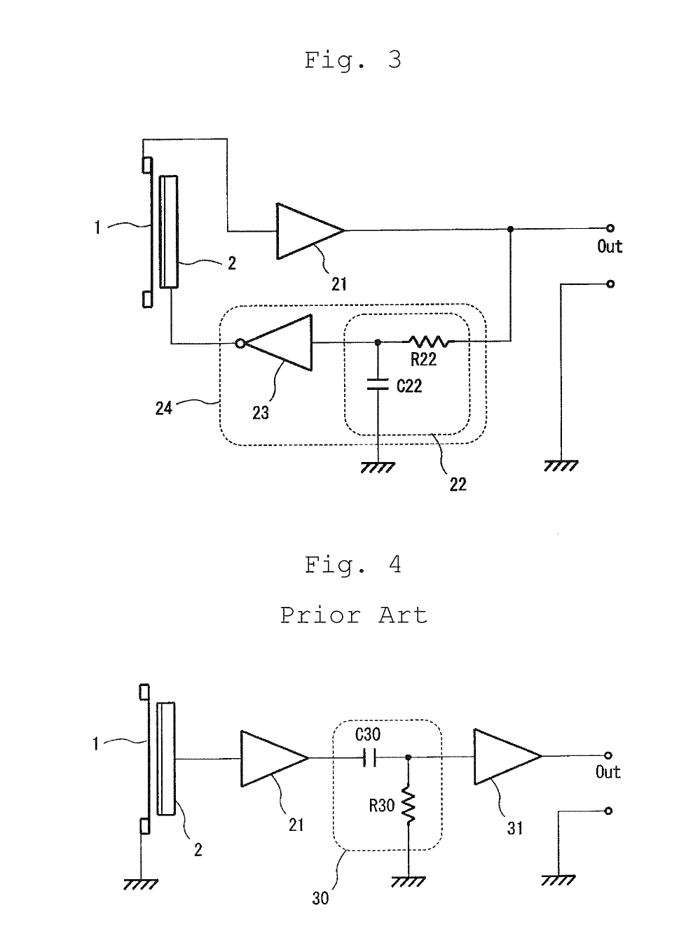

FIG. 3 illustrates a second example of the signal generation circuit mounted on the condenser microphone according to the present invention.

In the example illustrated in FIG. 3, the diaphragm 1 is connected to the input terminal of the impedance converter 21 and the output terminal of the low frequency inversion signal generation circuit 24 is connected to the fixed electrode 2. The other circuit configuration is the same as the circuit configuration of the example illustrated in FIG. 1.

According to the example illustrated in FIG. 3, the impedance converter 21 performs a function of extracting a change in capacitance between the diaphragm 1 and the fixed electrode 2 in the microphone unit as an audio signal from the side of the diaphragm 1.

In addition, the low frequency inversion signal from the low frequency inversion signal generation circuit 24 for the wind noise or the vibration noise is applied to the fixed electrode 2 and is added to an audio signal generated from the microphone unit.

In the example illustrated in FIG. 3, the same function and effect as those in the configuration illustrated in FIG. 1 can be obtained.

What is claimed is:

1. A condenser microphone comprising:
a condenser microphone unit including a diaphragm and a fixed electrode arranged at a predetermined interval to face each other; and
an impedance converter configured to convert a change in capacitance between the diaphragm and the fixed electrode of the condenser microphone unit into an audio signal, wherein
an output terminal of the impedance converter is connected to a low frequency inversion signal generation circuit including a low-pass filter and a phase inversion circuit and configures an audio signal output terminal of the condenser microphone, an output terminal of the low frequency inversion signal generation circuit is connected to the diaphragm, and an input terminal of the impedance converter is connected to the fixed electrode.

2. A condenser microphone comprising:
a condenser microphone unit including a diaphragm and a fixed electrode arranged at a predetermined interval to face each other; and
an impedance converter configured to convert a change in capacitance between the diaphragm and the fixed electrode of the condenser microphone unit into an audio signal, wherein
an output terminal of the impedance converter is connected to a low frequency inversion signal generation circuit including a low-pass filter and a phase inversion circuit and configures an audio signal output terminal of the condenser microphone, an output terminal of the low frequency inversion signal generation circuit is connected to the fixed electrode, and an input terminal of the impedance converter is connected to the diaphragm.

3. The condenser microphone according to claim 1, wherein an audio signal output of the condenser microphone is an unbalanced output.

4. The condenser microphone according to claim 2, wherein an audio signal output of the condenser microphone is an unbalanced output.

5. The condenser microphone according to claim 1, wherein the low frequency inversion signal generation circuit includes the low-pass filter connected to the output terminal of the impedance converter and the phase inversion circuit connected to an output terminal of the low-pass filter and an output terminal of the phase inversion circuit configures the output terminal of the low frequency inversion signal generation circuit.

6. The condenser microphone according to claim 2, wherein the low frequency inversion signal generation circuit includes the low-pass filter connected to the output terminal of the impedance converter and the phase inversion circuit connected to an output terminal of the low-pass filter and an output terminal of the phase inversion circuit configures the output terminal of the low frequency inversion signal generation circuit.

7. The condenser microphone according to claim 1, wherein an electret layer is arranged on a surface of the fixed electrode facing the diaphragm.

8. The condenser microphone according to claim 2, wherein an electret layer is arranged on a surface of the fixed electrode facing the diaphragm.
